(19) United States
(12) Patent Application Publication
(10) Pub. No.: US 2005/0112252 A1
(43) Pub. Date: May 26, 2005

(54) Method to extend the shelf-life of food products using hydrostatic high-pressure processing

(76) Inventor: Gaurav Tewari, San Antonio, TX (US)

Correspondence Address: JACKSON WALKER L.L.P., Suite 2100, 112 E. Pecan Street, San Antonio, TX, 78205, US

(21) Appl. No.: 10/994,812

(22) Filed: Nov. 22, 2004

Related U.S. Application Data
(60) Provisional application No. 60/524,375, filed on Nov. 20, 2003.

(51) Int. Cl. C12C 3/04

(52) U.S. Cl. 426/392

(57) ABSTRACT

A method of hydrostatic high pressure food processing to extend the shelf life of food products. The method calls for the application of hydrostatic pressure in the range of 10,000 psi to 130,000 psi for a period of 0.1 second to 7,200 seconds to effectively inactivate pathogenic microorganisms within the food product. The inactivation of pathogenic microorganisms significantly extends the shelf life of a food product.

This application claims priority from U.S. Application No. 60/524,375 filed Nov. 20, 2003 and incorporates by reference the '375 application as if it were fully printed herein.

### FIELD OF THE INVENTION

Applicant's invention relates food preparation. More particularly, Applicant's invention relates to the extension of the shelf-life of food products by using hydrostatic high-pressure processing to inactivate pathogenic microorganisms.

### BACKGROUND

The preservation of food has been a driving force in the advancement of science. As early as the beginning of the 19th century, major breakthroughs in food preservation had begun. Early efforts at food preservation included the curing of meat products with salt. These poorly cured foods provided minimal nutritional value, and led to frequent outbreaks of scurvy.

Napoleon Bonaparte began the search for a better mechanism of food preservation by offering a large prize to the person who devised a safe and dependable food-preservation process. The winner was a French chemist named Nicolas Appert who observed that food heated in sealed containers was preserved as long as the container remained unopened or the seal did not leak.

This was the turning point in food preservation history. Fifty years following the discovery by Nicolas Appert, another breakthrough had developed. Another Frenchman, named Louis Pasteur, noted the relationship between microorganisms and food spoilage. This breakthrough increased the dependability of the food canning process.

As the years passed new techniques assuring food preservation would come and go, opening new doors to further research. Today there are six major methods of preservation used by food processors. These six methods are canning, drying or dehydration, freezing, freeze-drying, fermentation or pickling, and irradiation.

A major drawback of these six methods is that each results in a loss of nutritional content as well as a loss of the sensory characteristics (e.g., taste, texture, color, aroma) of the processed food. Modern consumers demand food products with no preservatives and minimal processing which are also nutritional and have fresh-like taste. The current methods of food preservation fail to meet these demands.

Therefore, a need exists for a method to process foods so that shelf life will be extended while reducing the impact on taste, texture, color and aroma of the processed food.

### SUMMARY OF THE INVENTION

Applicant's invention satisfies this need by providing a method to inactivate pathogenic bacteria, yeasts, and molds with no heat treatment through the use of hydrostatic high-pressure processing, resulting in extended shelf life of foods with minimal loss of nutritional and sensory characteristics.

High pressure processing (HPP), also known as high hydrostatic pressure processing (HHPP), subjects liquid and solid foods, with or without packaging, to pressures between 10,000 psi and 130,000 psi. Process temperature during pressure treatment can be specified from about 10° Fahrenheit (to minimize any effects of adiabatic heat) to above 212° Fahrenheit.

Commercial exposure times at pressure can range from a sub-second application of pressure to a treatment time of over 7200 seconds (2 hours).

Pressures used in the HPP of foods appear to have little effect on covalent bonds; thus, foods subjected to HPP treatment at or near room temperature will not undergo significant chemical transformations due to the pressure treatment itself HPP may also be combined with heat to achieve an increased rate of inactivation of pathogenic bacteria, yeasts, and molds.

During HPP, transmission of pressure from the pressurizing medium (usually water) to the food products takes place instantaneously and uniformly via the water content in the food product. An optimum moisture content in the food products is needed for sufficient pressure transfer to the food. Presence of sufficient moisture in the food during HPP can be compared with sufficient thermal or electrical conductivity of foods required during convention or ohmic heating, respectively.

A primary advantage of HPP is its capacity to inactivate pathogenic microorganisms with minimal heat treatment, resulting in the almost complete retention of nutritional and sensory characteristics of a food product without sacrificing shelf life. Other advantages of HPP over traditional thermal processing include reduced process times; retention of flavor, texture, and color; no vitamin C loss; no undesirable changes in food during pressure-shift freezing due to reduced crystal size and multiple ice-phase forms; and minimal undesirable functionality alterations.

### BRIEF DESCRIPTION OF THE DRAWINGS

FIG. 1 is a graph depicting the adiabatic heating during high pressure processing of blue cheese salad dressing.

FIG. 2 is a graph depicting the adiabatic heating during high pressure processing Mexican salsa.

FIG. 3 is a graph showing enumeration of molds in un-treated blue cheese salad dressing.

FIG. 4 is a graph showing enumeration of Standard Plate Count (SPC) in pressure-treated blue cheese salad dressing. The Standard Plate Count is used as an indicator of the level of bacteria in a sample.

FIG. 5 is a graph showing enumeration of AACC in pressure-treated blue cheese salad dressing.

FIG. 6 is a graph showing enumeration of lactic acid bacteria (LAB) in pressure-treated blue cheese salad dressing.

FIG. 7 is a graph showing enumeration of molds in untreated salsa.

FIG. 8 is a graph showing enumeration of Standard Plate Count (SPC) in pressure-treated salsa.

FIG. 9 is a graph showing enumeration of AACC in pressure-treated salsa.

FIG. 10 is a table showing enumeration of microorganisms in black pepper samples before and after high pressure processing.

FIG. 11 is a flow diagram depicting one embodiment of the method of the invention disclosed herein.

### DESCRIPTION

The method of the present invention utilizes hydrostatic high-pressure processing to extend the shelf-life of food products by inactivating pathogenic microorganisms. As more specifically set out below, the steps of the method are placing a food product into a high oxygen barrier, flexible, sealable container; removing all of the air from the container; sealing the container; placing the container into a high pressure food processor; adjusting the temperature of the pressurizing medium to a minimum of 10 degrees Fahrenheit (−12° C.) so as to reduce the effects of adiabatic heating; adjusting the pressure within the high pressure food processor up to between 10,000 and 130,000 psi; holding the pressure for a minimum of 0.1 seconds; releasing the pressure; and removing the food product from the food processor. The high pressure food processor of the present invention may be any commercially available high pressure food processor such as Avure Technologies' Model 35L or Elmhurst Research's Model 25L.

During experimental tests, it was observed that by adhering to the method as disclosed, the presence of pathogenic organisms within a food product was substantially reduced. The first experimental test involved the sealing of blue cheese salad dressing in a sterile linear high density polyethylene pouch using a commercial sealer such as the Multivac Model C500. The second experimental test involved the sealing of Mexican salsa in a sterile linear high density polyethylene pouch using a commercial sealer such as the Multivac Model C500. In each experiment, the product was cooled to a temperature of approximately 4° C. The blue cheese dressing samples were processed at 87,000 psi for 45, 90, and 180 seconds, and the Mexican salsa was processed at 87,000 psi for 120 seconds. In each experiment, the pressurizing medium was water and was at approximately 12° C. The use of a liquid pressurizing medium ensures a uniform compaction pressure throughout the sample.

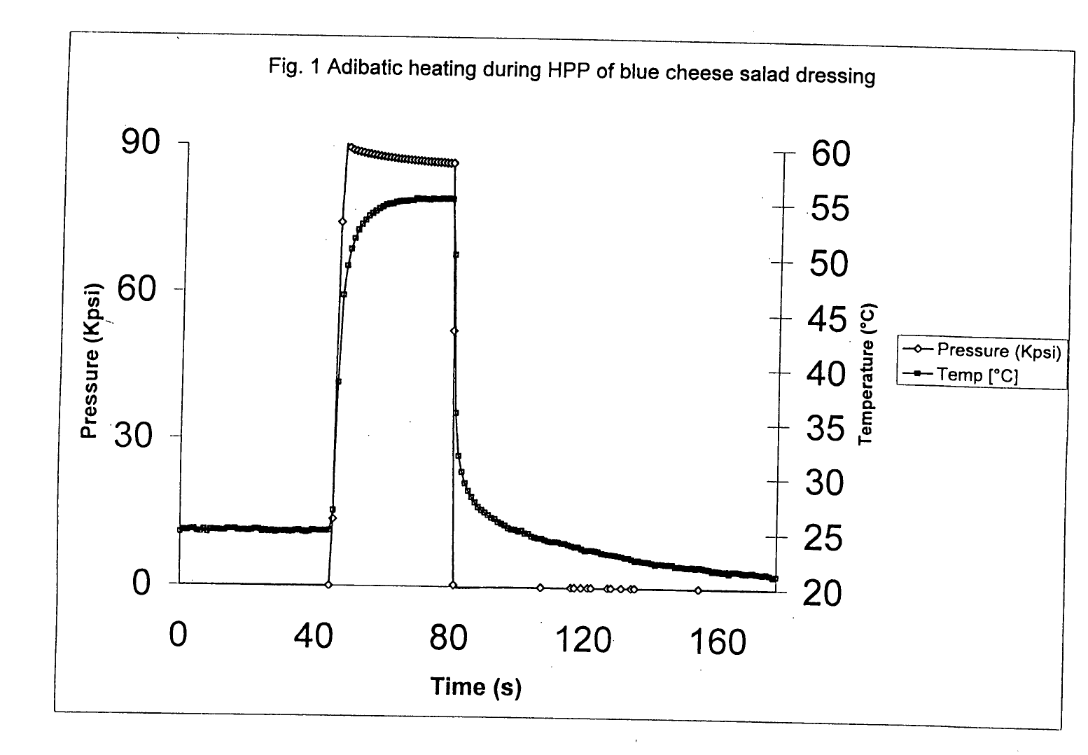

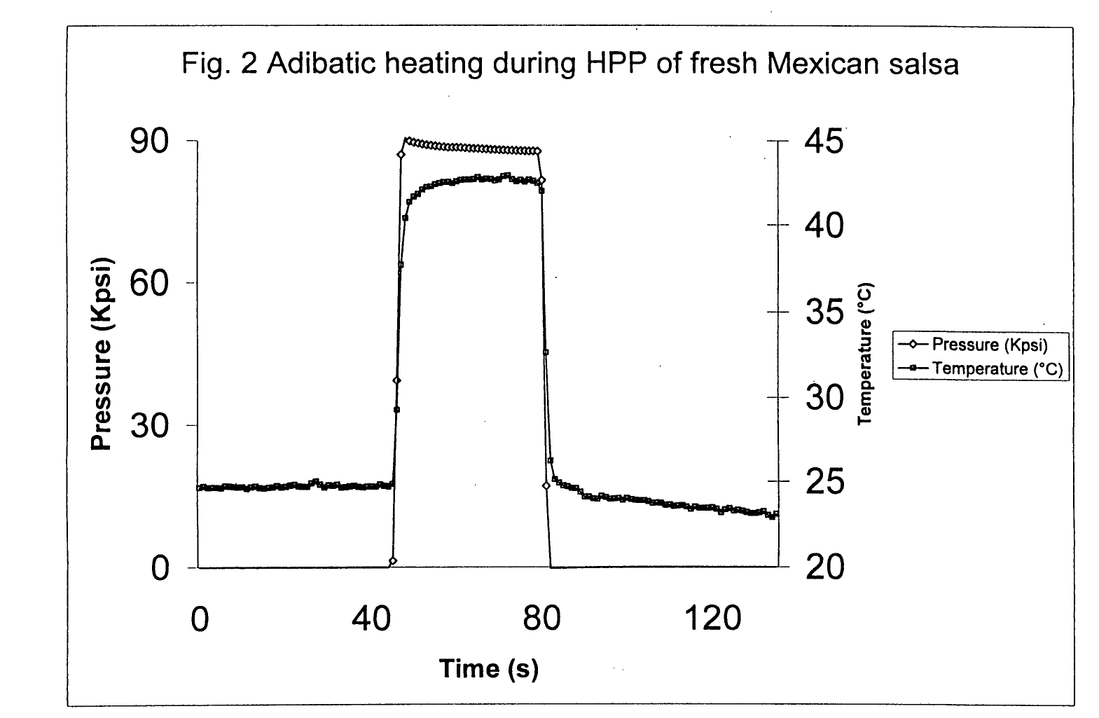

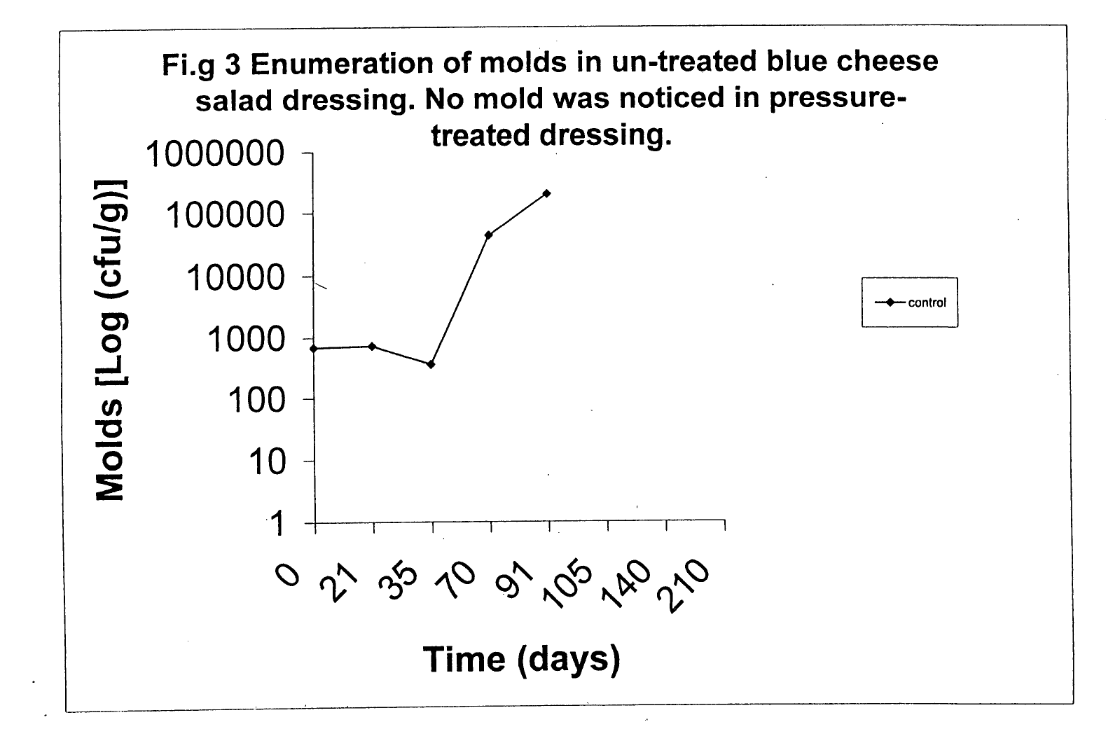

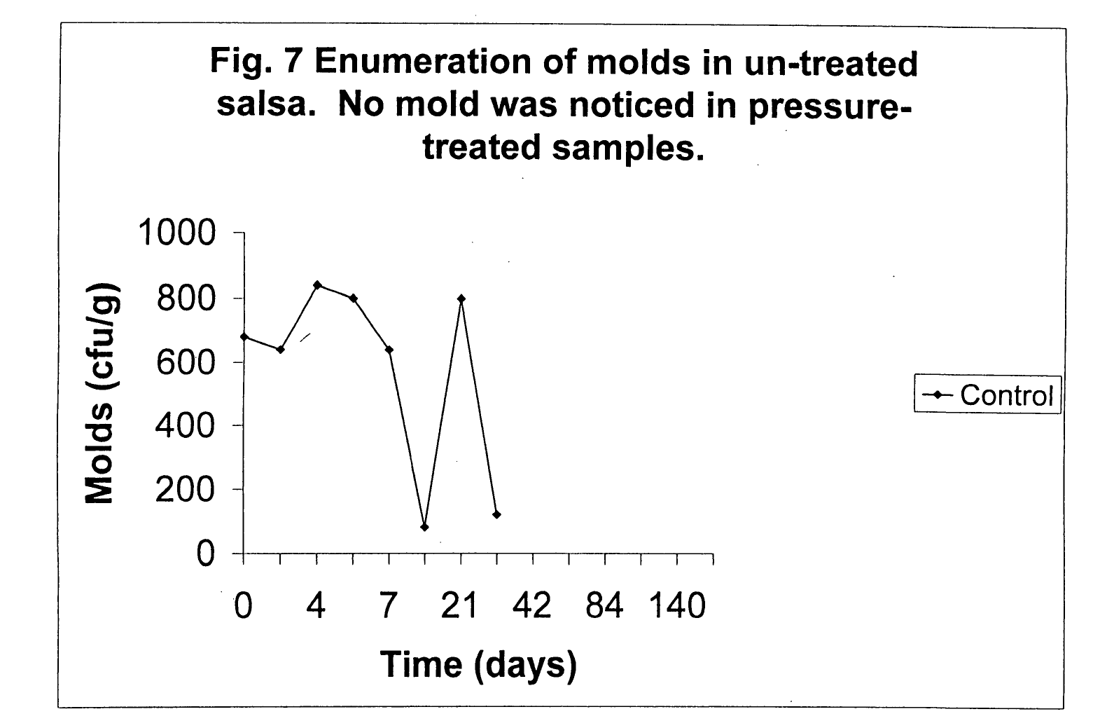

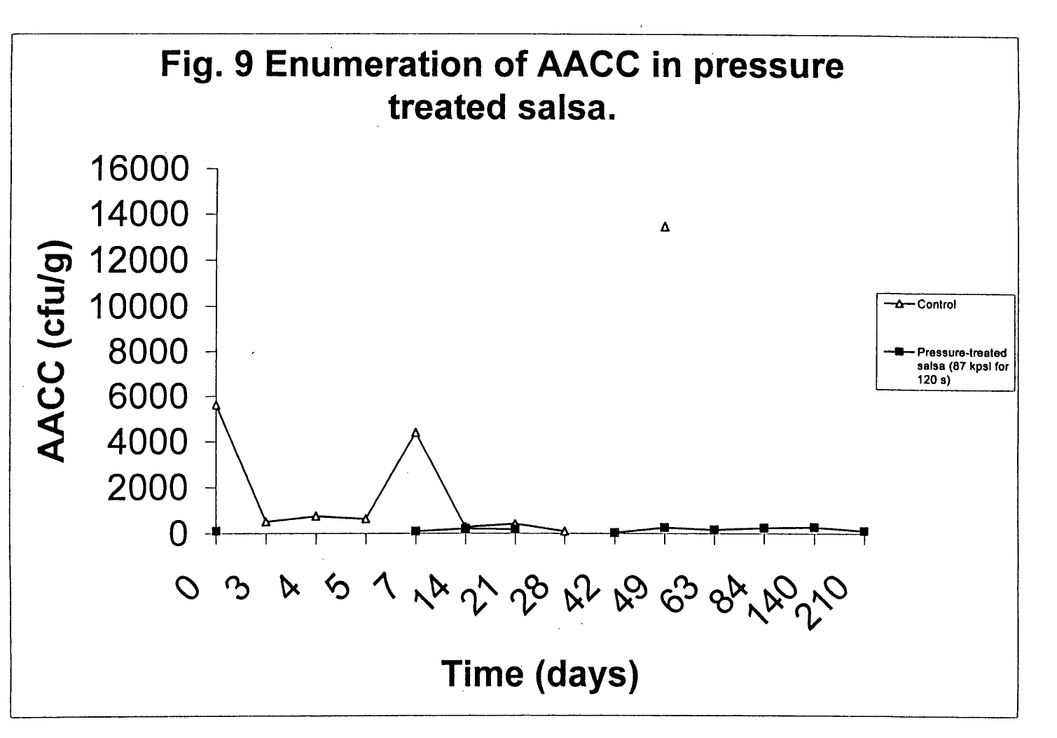

FIG. 1 and FIG. 2 show the pressure and temperature profiles of the blue cheese dressing and salsa, respectively, in the unit. Microbiological data for the blue cheese salad dressing is shown in FIGS. 3 through 6 and the data for the salsa is shown in FIGS. 7 through 9.

FIG. 1 and FIG. 2 both show a sharp increase in the temperature of the subject product when pressure is applied. This is the result of “adiabatic heating,” heat that is generated as a fluid (defined as either a liquid or gas) is being compressed during pressurization. Whenever the pressure within the chamber rises, it is accompanied by a corresponding rise in the temperature of the contents of the chamber even though no heat is applied. The amount of adiabatic heating temperature increase depends on the nature of the product. Products with high fat content undergo larger increases in temperature than those with lower fat content. This result is illustrated by the relative increases in the temperature of the high fat salad dressing of 30° C., FIG. 1, versus the increase of temperature of the low fat salsa of 17° C., FIG. 2.

The actual processing temperatures of the two products during the processing runs is estimated to be 34° C. for the blue cheese dressing and 21° C. for the salsa. This emphasizes the importance of having the food product at as low a temperature as possible when it is loaded into the chamber of the food processor and using a cold pressuring medium in order to maintain the fresh characteristics in the processed product.

FIG. 3 shows the mold population measured in the blue cheese salad dressing subsequent to high pressure processing. The mold population of all the treated samples were less than 10 cfu/g for at least 140 days after treatment, regardless of the duration of the high pressure processing. The untreated sample showed a mold population of 680 cfu/g that remained relatively stable until after day 35. At day 70, the count in the untreated sample had increased to 45,000 cfu/g, rendering the dressing unfit for consumption. This experiment shows that the HPP destroyed all the viable mold present in the dressing and extended the shelf life of the dressing by nearly three months. As seen in FIG. 7, a similar result was achieved for the Mexican salsa experiment.

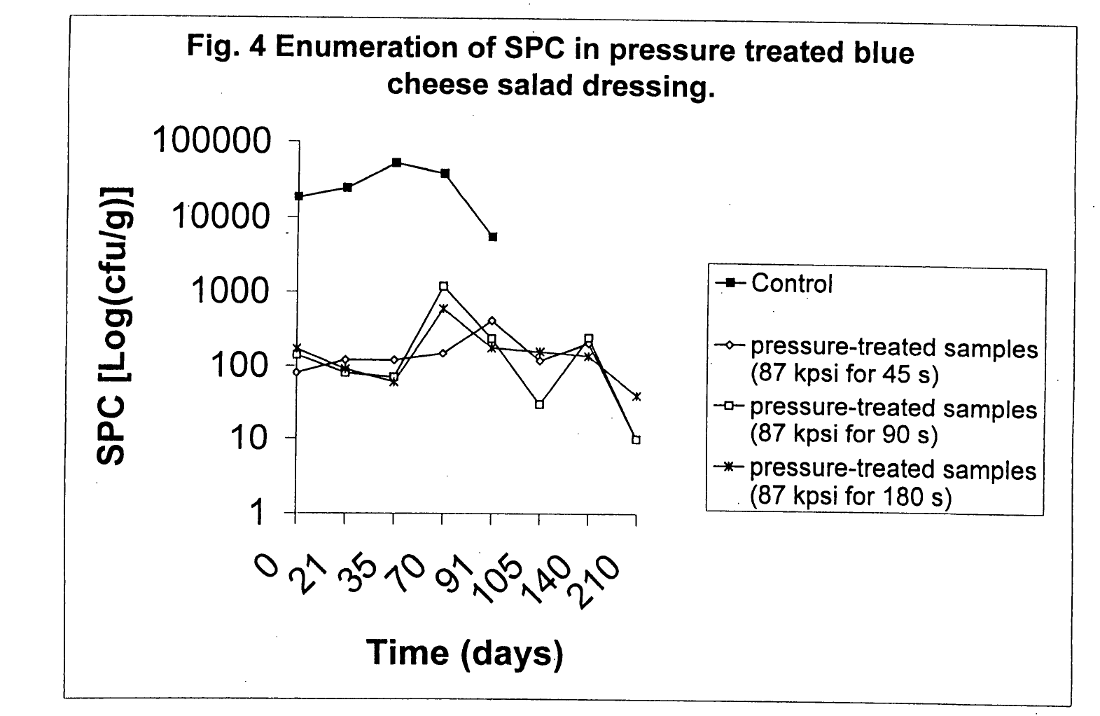

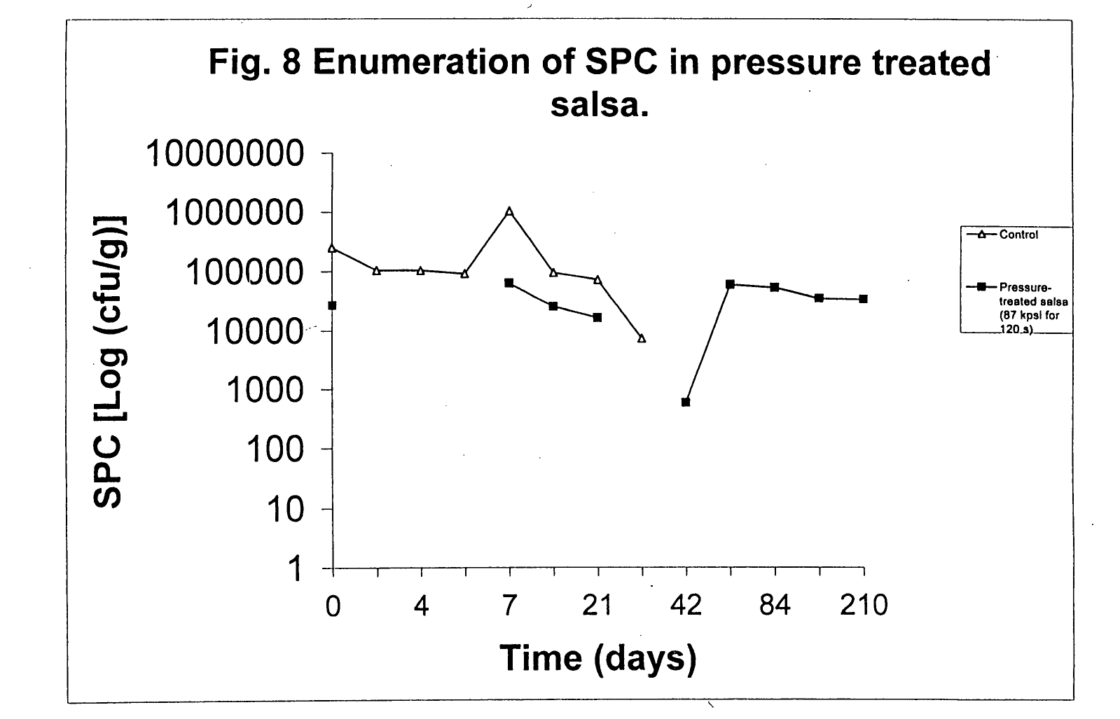

FIG. 4 shows the Standard Plate Counts (SPC) on each of the blue cheese samples. The SPC for the blue cheese salad dressing shows low activity of less than 200 cfu/g in the treated samples for the duration of the experiment. Meanwhile, the untreated sample has a high initial count of 19,000 cfu/g that shows a predictable increase over time followed by a decrease as the nutrient for the microorganisms is depleted. As seen in FIG. 8, a similar result was achieved for the Mexican salsa experiment.

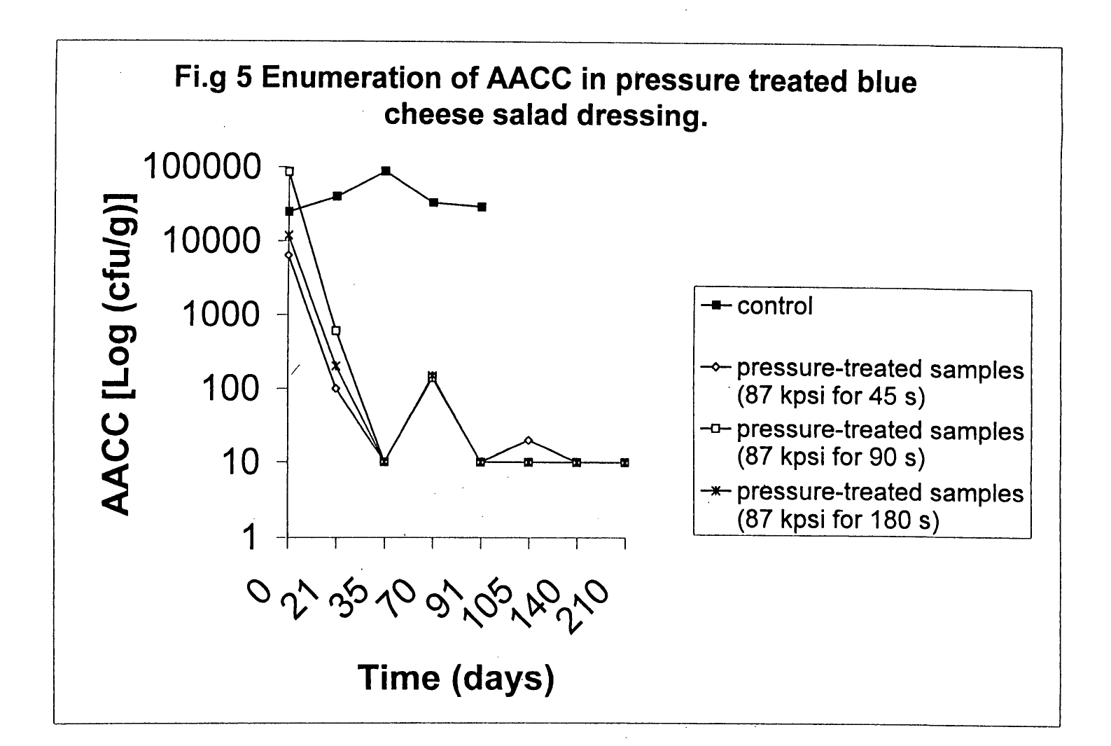

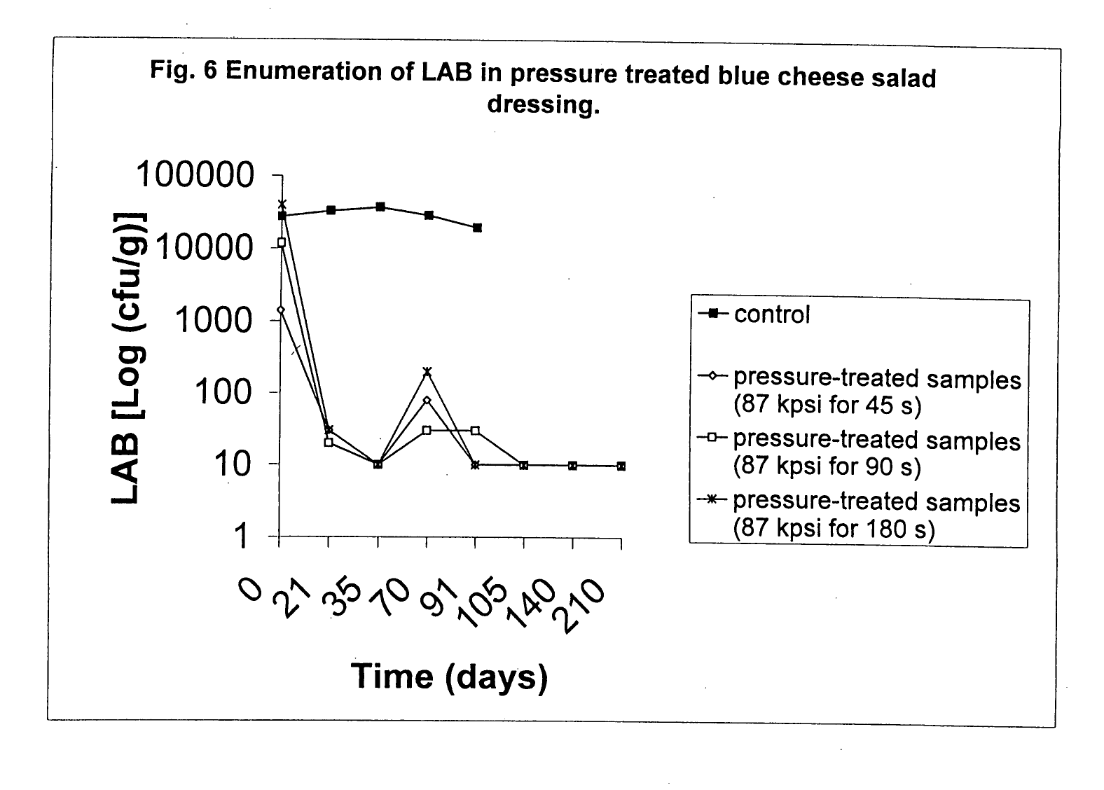

FIG. 5 shows that the anaerobic colony count (AACC) of the untreated samples remained relatively constant throughout the experiment. By contrast, the treated samples had higher count immediately after processing followed by a significant decrease thereafter. FIG. 6 illustrates that a similar trend was observed for the LAB count.

A third experiment was conducted utilizing black pepper. Decontamination of spices has proven to be a very difficult problem to solve. For example, black pepper has been found to be contaminated with more than 10⁷ cfu/g of microorganisms. The natural microflora of commercial black pepper usually consists of microorganisms which survive drying and storage; primarily aerobic spore formers, such as Bacillus cereus.

The black pepper experiment involved dry (10-15% moisture content) and moist (44% moisture content) unground black pepper samples. The samples were vacuum packaged. The samples were subjected to 87,000 psi for 300 seconds in an Avure Technologies' Model 35L high pressure food processor. Some samples were at 23° C. while others were at 50° C.

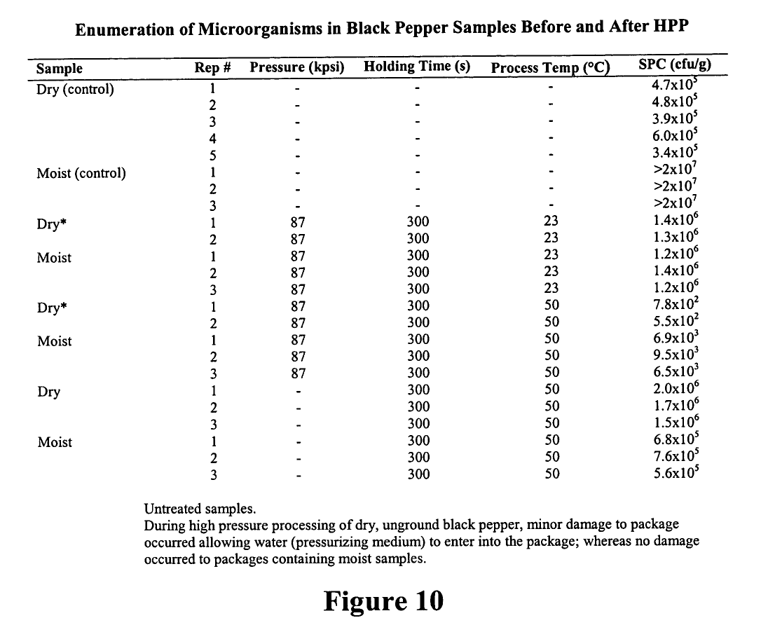

FIG. 10 shows a table which outlines the processing conditions and corresponding microbial population before and after high pressure processing. As can be seen in the table, the application of pressure alone, without increased temperature (the 23° C. samples), did not inactivate microbes on both dry and moist black pepper samples. Application of pressure alone actually increased microbial population by one log in dry samples and decreased microbial population by one log for most samples. Application of heat only (temperature equal 50° C.) caused an increase of one log in microbial population for dry samples, whereas it reduced the microbial population by two log for the moist samples. However, the combination of pressure (87 kpsi) and temperature (50° C.) resulted in three and greater than four log reduction in the microbial population for dry and moist black pepper samples, respectively.

A final experiment was conducted utilizing fresh fruit; specifically, freshly sliced cantaloupes and peaches. Typically, such cut fruits are preserved with preservatives because of their short shelf life as low as a few days.

The diced fruit were placed in a high oxygen barrier bag (i.e., a bag with an oxygen transmission rate<=0.55 cc/m²/24 hr/1 atm). The packages containing the deiced fruit were vacuum packaged and sealed. The diced fruit packages were processed at 10 kpsi, 25 kpsi, and 40 kpsi for 120 seconds, 480 seconds, and 1800 seconds, respectively. The initial temperature of the packaged fruit was approximately 40° Fahrenheit. The temperature of the pressurizing medium (water) was approximately 70° Fahrenheit.

After two weeks of storage, the processed cut fruit showed acceptable sensory and microbial characteristics. The sensory and microbial characteristics were better at pressure level of 40 kpsi and holding time of 1800 seconds when compared with the pressure levels of 10 kpsi and 25 kpsi and holding times of 120 seconds and 480 seconds, respectively. This shows that high pressure processing can be used for shelf life extension of fresh cut fruits.

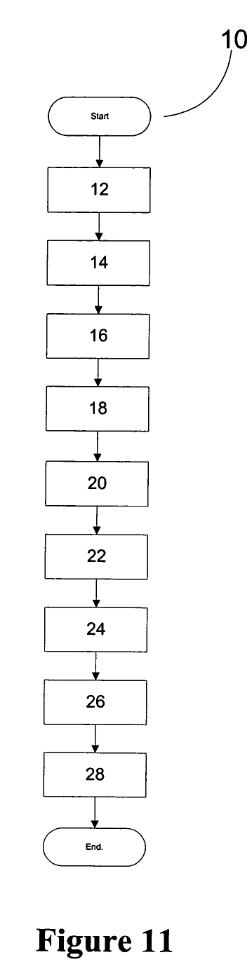

Referring now to FIG. 11 which depicts an embodiment of a method of the present invention to extend the shelf-life of food products by using hydrostatic high-pressure processing (10). As depicted in FIG. 11, a food product which is desired to be preserved is placed into a high oxygen barrier, flexible, sealable container (12), the fat content, moisture content, and pH level of the food product being determined prior to insertion into the sealable container so that the temperature of the food product and pressurizing medium, the proper pressure, and the proper time for holding the pressure may be determined. In the preferred embodiment, the high oxygen barrier, flexible, sealable container will have an oxygen transmission rate less than 60 cc/m² at one atmosphere external pressure over the course of 24 hours. An example of such a container is one a container composed of ethylene vinyl hydroxide. A foil lining within a container may also be used to reduce the oxygen transmission rate.

Once the food product is placed into the sealable container, substantially all of the air within the container must be removed (14). In one embodiment, the air is removed from the sealable container via a vacuum system. In another embodiment, the air may be displaced by water. One advantage of using water to displace the air within the sealable container is that the water enhances the high pressure processing. After the air has been removed from the sealable container (14), the container is sealed (16) and placed into a high pressure food processor (18).

The sealable container is then immersed in a liquid pressurizing medium (20). The use of a liquid pressurizing medium ensures a uniform compaction pressure throughout the sample. The pressurizing medium is usually water. However, a mixture of oil and water may be used when it is desirable to increase the temperature of the pressurizing medium.

The temperature of the pressurizing medium is then sent to a minimum of 10 degrees Fahrenheit (22). Generally, a lower initial temperature of the pressurizing medium is preferable as this reduces the effects of adiabatic heating. However, it is sometimes preferable to increase the temperature of the pressurizing medium to enhance the effectiveness of the high pressure food processor. Where a food product has a high fat content, the temperature of the pressurizing medium will generally be adjusted within an initial range of 23 degrees Fahrenheit and 33 degrees Fahrenheit. Where a food product has a high moisture content, the temperature of the pressurizing medium will generally be adjusted within an initial range of 33 degrees Fahrenheit and 43 degrees Fahrenheit. Where a food product has a pH level less than 5.6, the temperature of the pressurizing medium will generally be adjusted within an initial range of 10 degrees Fahrenheit and 75 degrees Fahrenheit. Where a food product has a pH level greater than or equal 5.6, the temperature of the pressurizing medium will generally be adjusted within an initial range of 60 degrees Fahrenheit and 212 degrees Fahrenheit.

Pressure is then applied to the food product and held for a specified duration (24). The range of pressure applied will vary between 10,000 psi and 130,00 psi. The minimum duration for which pressure is applied to the food product is 0.1 seconds. The pressure may be held for as long as 7,200 seconds.

After the expiration of the specified time duration, the pressure on the food product is released (26) and the food product is removed from the high pressure food processor (28). At this time, the shelf life of the food product has been extended due to the inactivation of pathogenic microorganisms.

In conclusion, a method is presented to extend the shelf-life of food products by using hydrostatic high-pressure processing. The invention is illustrated by example in the drawing figures, and throughout the written description. Although the invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover such modifications that fall within the scope of the invention.

1. A method to extend the shelf-life of food products using hydrostatic high-pressure processing, the method comprising the steps of:
placing a food product into a high oxygen barrier, flexible, sealable container;
removing substantially all of the air from said sealable container;
sealing said sealable container;
placing said sealable container into a high pressure food processor;
immersing said sealable container in a pressurizing medium inside said high pressure food processor;
adjusting the temperature of said pressurizing medium to approximately 10 degrees Fahrenheit to reduce the effects of adiabatic heating;
adjusting the pressure within said high pressure food processor to between 10,000 psi and 130,000 psi;
holding said pressure for a minimum of 0.1 seconds; and
releasing said pressure and removing said food product from said food processor.

2. The method of claim 1 wherein air is displaced from said sealable container by water.

3. The method of claim 1 wherein said high oxygen barrier, flexible, sealable container has an oxygen transmission rate less than 60 cc/m² at one atmosphere external pressure over the course of 24 hours.

4. The method of claim 3 wherein said high oxygen barrier, flexible, sealable container is composed of ethylene vinyl hydroxide.

5. The method of claim 3 wherein said high oxygen barrier, flexible, sealable container includes a foil lining.

6. The method of claim 1 wherein said pressurizing medium is water.

7. The method of claim 1 wherein said pressurizing medium is a mixture of water and oil.

8. The method of claim 1 wherein said high pressure food processor is immersed in cool water to reduce the effects of adiabatic heating.

9. The method of claim 1 wherein said food product has a high fat content and the temperature of said pressurizing medium is adjusted to a range of 23 degrees Fahrenheit and 33 degrees Fahrenheit.

10. The method of claim 1 wherein said food product has a high moisture content and the temperature of said pressurizing medium is adjusted to a range of 33 degrees Fahrenheit to 43 degrees Fahrenheit.

11. The method of claim 1 wherein said food product has a pH level less than 5.6, the temperature of said pressurizing medium is adjusted to a range of 10 degrees Fahrenheit to 75 degrees Fahrenheit, and the pressure is held for a period between 0.1 seconds and 7200 seconds.

12. The method of claim 1 wherein said food product has a pH level greater than or equal to 5.6, the temperature of said pressurizing medium is adjusted to a range of 60 degrees Fahrenheit to 212 degrees Fahrenheit, and the pressure is held for a period between 0.1 seconds and 7200 seconds.

13. A method to extend the shelf-life of food products using hydrostatic high-pressure processing, the method comprising the steps of:
placing a food product into a high oxygen barrier, flexible, sealable container;
removing substantially all of the air from said sealable container;
sealing said sealable container;
placing said sealable container into a high pressure food processor;
immersing said sealable container in a pressurizing medium inside said high pressure food processor;
adjusting the temperature of said pressurizing medium to between 23 degrees Fahrenheit and 212 degrees Fahrenheit;
adjusting the pressure within said high pressure food processor to between 10,000 psi and 130,000 psi;
holding said pressure between 0.1 seconds and 30 seconds; and
releasing said pressure and removing said food product from said food processor.

14. The method of claim 13 wherein air is displaced from said sealable container by water.

15. The method of claim 13 wherein said high oxygen barrier, flexible, sealable container has an oxygen transmission rate less than 60 cc/m² at one atmosphere external pressure over the course of 24 hours.

16. The method of claim 15 wherein said high oxygen barrier, flexible, sealable container is composed of ethylene vinyl hydroxide.

17. The method of claim 15 wherein said high oxygen barrier, flexible, sealable container includes a foil lining.

18. The method of claim 13 wherein said pressurizing medium is water.

19. The method of claim 13 wherein said pressurizing medium is a mixture of water and oil.

20. The method of claim 13 wherein said high pressure food processor is immersed in cool water to reduce the effects of adiabatic heating.

21. The method of claim 13 wherein said food product has a high fat content and the temperature of said pressurizing medium is adjusted to a range of 23 degrees Fahrenheit and 33 degrees Fahrenheit.

22. The method of claim 13 wherein said food product has a high moisture content and the temperature of said pressurizing medium is adjusted to a range of 33 degrees Fahrenheit to 43 degrees Fahrenheit.

23. The method of claim 13 wherein said food product has a pH level less than 5.6, the temperature of said pressurizing medium is adjusted to a range of 10 degrees Fahrenheit to 75 degrees Fahrenheit, and the pressure is held for a period between 0.1 seconds and 7200 seconds.

24. The method of claim 13 wherein said food product has a pH level greater than or equal to 5.6, the temperature of said pressurizing medium is adjusted to a range of 60 degrees Fahrenheit to 212 degrees Fahrenheit, and the pressure is held for a period between 0.1 seconds and 7200 seconds.

25. A method to extend the shelf-life of food products using hydrostatic high-pressure processing, the method comprising the steps of:
cooling the food product to approximately 34 degrees Fahrenheit to retard adiabatic heating;
placing a food product, said food product having a high fat content, into a high oxygen barrier, flexible, sealable container wherein said container has an oxygen transmission rate less than 60 cc/m² at one atmosphere external pressure over the course of 24 hours, said sealable container composed of ethylene vinyl hydroxide;
removing substantially all of the air from said sealable container by displacing it with water;
sealing said sealable container;
placing said sealable container into a liquid pressurizing medium within a high pressure food processor, said liquid pressurizing medium being composed substantially of water;
adjusting the temperature of said pressurizing medium to between approximately 12 degrees Celsius to retard the effects of adiabatic heating;
immersing said high pressure food processor in cool water to reduce the effects of adiabatic heating;
adjusting the pressure within said high pressure food processor to between approximately 85,000 psi and approximately 90,000 psi;
holding said pressure approximately 40 seconds; and
releasing said pressure and removing said food product from said food processor.

26. The method of claim 25 wherein said high oxygen barrier, flexible, sealable container includes a foil lining.

27. A method to extend the shelf-life of food products using hydrostatic high-pressure processing, the method comprising the steps of:
placing a food product, said food product having a moisture content between approximately 10% and approximately 44%, into a high oxygen barrier, flexible, sealable container wherein said container has an oxygen transmission rate less than 60 cc/m² at one atmosphere external pressure over the course of 24 hours, said sealable container composed of ethylene vinyl hydroxide;
removing substantially all of the air from said sealable container;
sealing said sealable container;
placing said sealable container into a liquid pressurizing medium within a high pressure food processor, said liquid pressurizing medium being composed substantially of water;
adjusting the temperature of said pressurizing medium to approximately 50 degrees Celsius to retard the effects of adiabatic heating and enhance the inactivation of pathogenic microorganisms;
adjusting the pressure within said high pressure food processor to approximately 87,000 psi;
holding said pressure for approximately 300 seconds; and
releasing said pressure and removing said food product from said food processor.
